(19) United States
(12) Patent Application Publication
(10) Pub. No.: US 2012/0136115 A1
(43) Pub. Date: May 31, 2012

(54) ISOCYANATE GROUP-CONTAINING PREPOLYMERS HAVING GOOD STORAGE STABILITY

(75) Inventors: Evelyn Peiffer, Leverkusen (DE); Christos Karafilidis, Leverkusen (DE); Matthias Wintermantel, Bergisch-Gladbach (DE); Christian Wamprecht, Neuss (DE)

(73) Assignee: Bayer MaterialScience AG, Leverkusen (DE)

(21) Appl. No.: 13/389,278

(22) PCT Filed: Jul. 28, 2010
(86) PCT No.: PCT/EP2010/004616

§ 371 Date: Feb. 7, 2012

(30) Foreign Application Priority Data
Aug. 11, 2009 (DE) 102009037009.9

(51) Int. Cl. C08G 18/02; C09D 175/04; C09J 175/04

(52) U.S. Cl. 524/590; 528/52

(57) ABSTRACT

The invention relates to adhesives, coating agents and sealing agents curing under the influence of moisture, which exhibit good storage stability, can be processed within a wide tolerance range and are fast-curing.

The invention provides one-component systems based on aliphatic prepolymers which cure under the influence of moisture and have a long storage life, a workability that can be adjusted within wide limits, and a rapid full cure.

Moisture-curing isocyanate-terminated prepolymers based on aromatic polyisocyanates such as TDI and preferably MDI, for example, are used as adhesives, sealants and coating compounds in diverse industrial and do-it-yourself (DIY) applications, depending on their isocyanate content.

Examples include the gluing of timber, the production of sandwich constructions from timber or aluminium sheets, for example, with insulating materials such as rock wool, EPS or PU rigid foams to form insulating elements as used in container construction, the production of automotive roof liner structures from a thermoplastic PU foam, a glass fibre nonwoven fabric and a decorative woven fabric, wherein the NCO prepolymer bonds the layers together but also reinforces the entire composite structure, or the consolidation of loose rock formations in road building. Preferred NCO ranges for this market segment are NCO contents of approx. 12 to 18 wt. %.

NCO-terminated prepolymers having NCO contents of approx. 6 to 12 wt. % produce more flexible polyurethanes after curing and are therefore suitable for the production of more flexible composites, such as for example the production of pelletised rubber compounds as surfacing elements for children's playgrounds.

Even more flexible polyurethanes are obtained with isocyanate-terminated prepolymers having isocyanate contents of 1 to 5 wt. %, which are widely used for example as structural sealants or as adhesive sealants in the automotive industry for fitting windscreens, etc.

A new class of PU adhesives are the reactive PU hot melts, which with isocyanate contents of 2 to 5 wt. % can also lead to very rigid PU, depending on the polyol used.

Common to all these prepolymers is the fact that the chain extension reaction of water with isocyanate groups leads to polyurea segments which impart high strength and outstanding physical properties (such as toughness, thermal stability, etc.) to the polyurethanes obtained.

The substantial advantage of the prepolymers is that they are one-component systems, because the reaction with water proceeds very reliably and requires no laborious stoichiometry considerations such as are required with two-component systems. The reaction always leads to a cured polyurethane, even with a large excess of water. The existing atmospheric and/or substrate moisture is normally sufficient as the reaction partner, but misting with water is also possible, especially with dense outer layers such as aluminium profiles, for example.

For practical use the open time of the systems is adjusted by the addition of catalysts. The open time is understood to be the time for which the systems remain readily workable after being applied to the substrates to be bonded. The term “workable” has to be redefined for each use. In the case of adhesives, workability is generally defined as the time for which two substrates can still easily be joined together. If the working time is exceeded, optimal properties such as for example the ability to reposition the substrates are generally no longer achievable.

The time that is required from the end of the working time until the optimal end properties are achieved should be as short as possible, because unduly long waiting times always mean higher costs in practice, such as longer residence times in the press, for example.

In practice the length of the working time can be freely adjusted in principle through the use of catalysts, although at the same time all catalysts also have a negative influence on the storage life of the systems (without the ingress of water), such that systems that have been adjusted to react very quickly also have a limited storage life, and this can adversely affect the product logistics. The limited storage life is demonstrated primarily by a sharp rise in viscosity, which can be up to the point of gelation. On the other hand, although some catalysts allow very effective control of the working time, they result in an unduly long cure time for the systems. This generally means that the parts have to be stored temporarily before processing can continue.

An overview of catalysts can be found for example in A. Farkas and G. A. Mills, Adva. Catalysis, 13, 393 (1962), J. H. Saunders and K. C. Frisch, Polyurethanes, Part I, Wiley-Interscience, New York, 1962, Chap. VI, K. C. Frisch and L. P. Rumao, J. Macromol. Sci.-Revs. Macromol. Chem., C5 (1), 103-150 (1970), or G. Woods, The ICI Polyurethane Book, John Wiley & Sons, p. 41-45, 1987.

Common catalysts are the products known in polyurethane chemistry, such as tertiary aliphatic amines and/or metal catalysts.

Thus metal catalysts such as dibutyl tin dilaurate, for example, exhibit excellent acceleration of the reaction of water with isocyanate-group-containing prepolymers, combined also with a good full cure, but at the same time they have a negative influence on storage life. An improvement is achieved in EP-A 0 132 675 by “blocking” the catalyst through the addition of tosyl isocyanate, but even the slightest traces of moisture are sufficient to lift this blocking, which overall leads to an improved but still inadequate storage life.

A mixture of various catalysts is usually used in practice in order to achieve the best possible combination of all properties.

A general disadvantage of prepolymers based on aromatic polyisocyanates is the tendency of the end products to become severely discoloured under the influence of light, which is prohibitive for many applications. A generally recognised principle for eliminating this disadvantage is the use of suitable additives, such as for example combinations of sterically hindered phenols and sterically hindered aliphatic amines (HALS types), which represent only a gradual improvement, however. The use of aliphatic polyisocyanates, such as for example hexamethylene diisocyanate, isophorone diisocyanate or 4,4′-diisocyanatodicyclohexylmethane in the form of mixtures of its steric isomers or the aforementioned diisocyanates in the form of their derivatives, represents a fundamental improvement.

With these polyisocyanates, however, in contrast to the aromatic polyisocyanates, the reaction with water proceeds only very sluggishly.

Very high concentrations of metal catalysts, such as for example dibutyl tin dilaurate or bismuth salts, are needed to catalyse the reaction at all. However, catalyst concentrations at this level always have a negative influence on long-term performance characteristics, such as for example the hydrolysis resistance of polyester-based adhesives, for example. The tertiary aliphatic amines very commonly used as catalysts for adhesives based on aromatic polyisocyanates, such as 1,4-diazabicyclooctane or dimorpholinodiethyl ether for example, have likewise proved to have little catalytic effect, cf. L. Havenith in Paint Manufacture, December 1968, p. 33-38, in particular p. 34. An additional problem with these catalysts is their ability to migrate from the cured systems. In systems used for food contact applications in particular, this is most undesirable.

Technically very complex procedures have likewise been discussed in the literature, in which the systems to be cured, mainly thin layers of coatings, are moisture-cured in chambers in the presence of highly volatile tertiary aliphatic amines, such as for example trimethylamine, and possibly at elevated temperature. As very high catalyst concentrations can be used with this procedure without remaining in the product, the problems described above do not arise.

DE-A 10 2006 020 605 describes bis(dimethylaminoethyl)ether as a catalyst for the reaction with moisture of aliphatic one-component polyurethane systems. One-component moisture-curing polyurethane systems are obtained which exhibit a high reaction rate in the reaction with moisture/water combined with good storage stability. However, bis(dimethylaminoethyl)ether is classed as toxic and can also migrate or evaporate out of the cured polyurethane, as bis(dimethylaminoethyl)ether is not covalently bonded to the polymeric polyurethane. Therefore preparations containing more than 1% bis(dimethylaminoethyl)ether must be labelled as toxic. Generally speaking, for health and safety reasons and in certain sensitive applications, preparations containing toxic substances are not desirable.

There is therefore a need for catalysts which allow good control of the working time while having only a slight adverse effect on the storage life of the systems but which at the same time allow a rapid full cure and cannot migrate out of the system subsequently and are not toxic.

The present invention thus provides one-component systems based on isocyanate-group-containing prepolymers on the basis of aliphatic polyisocyanates having isocyanate contents of 1 to 20 wt. %, characterised in that as the catalyst N,N,N′-trimethyl-N′-hydroxyethylbis(aminoethyl)ether is used as the sole catalyst or is incorporated along with other catalysts.

As a catalyst, N,N,N′-trimethyl-N′-hydroxyethylbis(aminoethyl)ether surprisingly exhibits a balanced ratio of working time to full cure time with only a slight influence on the thermal stability of the isocyanate-group-terminated prepolymers based on aliphatic polyisocyanates. This selected catalyst has been found to be bonded to the prepolymer via the hydroxyl group.

NCO-terminated prepolymers having isocyanate contents of 1 to 20 wt. %, preferably 2 to 16 wt. %, are understood to be reaction products of aliphatic polyisocyanates with hydroxyl polycarbonates, hydroxyl polyesters and/or hydroxyl polyethers, which as such or when formulated with plasticisers, fillers, rheological aids cure by means of the reaction with atmospheric and/or substrate moisture to form high-molecular-weight polyurethane polyureas.

Suitable aliphatic polyisocyanates are understood to be in particular hexamethylene diisocyanate, isophorone diisocyanate and 4,4′-diisocyanatodicyclohexylmethane in the form of mixtures of its steric isomers. Also included here is of course the use or incorporation of the aforementioned diisocyanates in the form of their derivatives, such as for example urethanes, biurets, allophanates, uretdiones and trimers and mixed forms of these derivatives.

The hydroxyl polycarbonates are understood to be reaction products of glycols of the ethylene glycol, diethylene glycol, 1,2-propylene glycol, butanediol-1,4, neopentyl glycol or hexanediol-1,6 type and/or triols such as for example glycerol, trimethylolpropane, pentaerythritol or sorbitol with diphenyl and/or dimethyl carbonate. The reaction is a condensation reaction in which phenol and/or methanol are eliminated. Depending on the composition, the result is liquid to waxy amorphous types having Tg values above −40° C. or crystalline polycarbonate polyols having melting ranges from 40 to 90° C. The molecular weight range is 200 to 10,000. The molecular weight range from 400 to 5000 is preferred. The molecular weight range from 500 to 3000 is particularly preferred.

The hydroxyl polyesters are understood to be reaction products of aliphatic dicarboxylic acids, such as for example adipic, azelaic, sebacic and/or dodecanoic diacid, and/or aromatic dicarboxylic acids, such as ortho-, iso- or terephthalic acid, with glycols of the ethylene glycol, diethylene glycol, 1,2-propylene glycol, butanediol-1,4, neopentyl glycol or hexanediol-1,6 type and/or polyols such as for example glycerol or trimethylolpropane, pentaerythritol or sorbitol. The reaction is a standard melt condensation as described in Ullmanns Enzyklopädie der technischen Chemie, “Polyester”, 4th Edition, Verlag Chemie, Weinheim, 1980. Depending on the composition, the result is liquid amorphous types having Tg values above −40° C. or crystalline polyester polyols having melting ranges from 40 to 90° C. The molecular weight range is 200 to 30,000. The molecular weight range from 400 to 5000 is particularly preferred. The molecular weight range from 500 to 5000 is particularly preferred.

The products which derive from reaction products of glycerol and hydroxyl fatty acids, in particular castor oil and its derivatives, such as for example monodehydrated castor oil, should also be mentioned here in particular.

The polyether polyols include in particular those normally produced by base-catalysed addition of propylene and/or ethylene oxide to starter molecules, such as for example water, propanediol-1,2, 2,2-bis(4-hydroxyphenyl)propane, glycerol, trimethylolpropane, triethanolamine, ammonia, methylamine or ethylene diamine, with molecular weights from 200 to 6000, in particular 200 to 5000. Also suitable in particular are the polypropylene ether polyols which are obtainable by means of double metal cyanide catalysts and which allow the synthesis of very high-molecular-weight well-defined polyether polyols with molecular weights of up to 25,000. Polyether polyols containing dispersed organic fillers such as for example addition products of toluylene diisocyanate to hydrazine hydrate or copolymers, of styrene and acrylonitrile for example, are also possible of course.

The polytetramethylene ether glycols obtainable by polymerisation of tetrahydrofuran and having molecular weights of 400 to 4000 can also be used, as too can polybutadienes containing hydroxyl groups.

Mixtures of the above polyols can of course also be used mixed with low-molecular-weight polyols such as for example ethylene glycol, butanediol, diethylene glycol or butenediol-1,4.

The aforementioned polyols can of course be reacted with all polyisocyanates, both aromatic and aliphatic, before the actual prepolymerisation to form urethane-modified hydroxyl compounds.

Production of the isocyanate-terminated prepolymers takes place by known methods by reacting the polyols with a stoichiometric excess of aliphatic polyisocyanates at temperatures of 30 to 150° C., preferably 60 to 140° C. This can take place discontinuously in reaction vessels or continuously in series of reaction vessels or using mixers.

It is particularly preferable for the hydroxyl compounds to be reacted with a large excess of diisocyanates and for the remaining monomeric diisocyanate to be removed from the prepolymer by known methods, such as for example by means of a film or short-path evaporator at elevated temperature and under reduced pressure. Prepolymers with a low monomer content are obtained in this way which in some cases, depending on the residual monomer content, no longer require special labelling.

Modified aliphatic polyisocyanates can also be added to all these products before, during or preferably after the reaction to optimise the properties. Such products are commercially available, under the names Desmodur® N 100 (HDI biuret modification) or Desmodur® N 3300 and Desmodur® N 3600 (HDI trimers) or Desmodur® Z 4470 (IPDI trimer) from Bayer MaterialScience AG, for example.

Various aggregates are possible, depending on the expected final viscosity which—depending on the formulation—can vary between low viscosity and high viscosity.

The catalyst N,N,N′-trimethyl-N′-hydroxyethylbis(aminoethyl)ether is added to the prepolymers before, during or preferably after the end of prepolymer formation.

The amount of this catalyst that is added is determined by the desired working time. As a general rule amounts from 0.01 to 3.0 wt. %, preferably 0.05 to 2.0 wt. %, particularly preferably 0.1 to 1.5 wt. %, relative to the prepolymer, are sufficient.

Solvents, fillers, dyes and rheological aids such as are known in practice can additionally be added to the prepolymers.

Chalk, barytes but also fibrous fillers such as polyamide or polyacrylonitrile fibres can be mentioned by way of example as fillers. Examples of rheological aids, in addition to the additives conventionally used in industry, such as aerosils, bentonites or hydrogenated castor oil, also include low-molecular-weight amines, which in combination with polyisocyanates very quickly establish a pseudoplasticity. With all of these additives it is absolutely essential to exclude moisture, since this would cause a premature reaction to take place in the container.

The adhesives, coating compounds and sealants are applied for example by means of knife application, trowel application, spraying, rolling, brushing, flat-film extrusion or in more compact form in the form of a bead.

A good method for assessing the various curing phases of such systems involves for example the use of commercial devices, such as for example the BK 10 drying recorder (The Mickle Laboratory Engineering Co. Ltd.), which are widely used in the paints, adhesives and sealants industry. Here a needle, loaded with a weight if necessary, is moved at a constant speed through a thin film of the prepolymer to be assessed on a support (e.g. a glass plate). Three phases are observed, which are defined by the terms “working time” and full cure time”.

Initially the needle moves through the liquid film and the trace left by the needle disappears more or less completely; this phase correlates to the working time. The end of the working time, which is also known as the skinning time, open time or contact tack time, is indicated by the first occurrence of a continuous trace left by the needle.

This is followed by a section of varying length (corresponding to the time elapsed) during which the needle leaves a trace. When the film is sufficiently fully cured, the needle can no longer penetrate the polymer film and the needle passes over the polymer film without leaving a trace; in metrological terms this is referred to as the full cure time. From a metrological perspective, the start of this state is of course linked both to the general composition of the adhesive and to the weight with which the needle is loaded, and thus it may not be synonymous with the time at which the polymer achieves its end properties. However, the time correlates very well with terms such as for example reaching “fixture strength”, “flex endurance”, etc.

The aim of the practitioner is to make the time between the end of the working time and reaching the full cure time as short as possible.

The invention provides the reduction of this time period with as unrestricted as possible a working time and with as little adverse effect as possible on the storage life of NCO-terminated prepolymers.

The invention also provides the use of prepolymers catalysed in this way as adhesives and/or sealants and/or coating compounds in which the aliphatic isocyanate groups cure with moisture. Possible applications include among other things the gluing of timber elements such as for example dovetail joints, laminated wood products or beams. The bonding of wood chips, wood fibres or wood dust to form sheets or mouldings is likewise possible. Prepolymers having isocyanate contents of approx. 10 to 20% are particularly suitable for these applications. Lower isocyanate contents are more suitable for low-molecular-weight polymers, such as for example for the use of non-discolouring light-coloured joint sealants or for the area of reactive PU hot melts, where such a prepolymer is applied at temperatures above 80° C. and strength is built up on cooling by means of physical processes and then the final reaction takes place with moisture (cf. EP-A 0 354 527).

The examples below are intended to illustrate the invention.

### EXAMPLES

### Experimental Part

### Example 1

### Prepolymer Production (HDI)

1000 g (4.59 mol) of polypropylene glycol with a hydroxyl value of 515 mg KOH/g stabilised with 30 ppm of isophthaloyl dichloride and 11,581 g (68.85 mol) of hexamethylene diisocyanate (RDI) are reacted at approx. 90 to 100° C. At the end of the reaction time of 3 hours the prepolymer has a constant NCO content of 42.6%. 205 ppm of zinc ethyl hexanoate are added at 90° C. to allophanatise the prepolymer.

At the end of the reaction time of 2 hours the allophanate has a constant NCO content of 36.9%. The allophanate stabilised with 230 ppm of isophthalyl dichloride is then largely freed from excess HDI monomer by distillation in a short-path evaporator at 140° C. and 0.1 mm Hg.

A low-viscosity prepolymer having an isocyanate content of 17.6% and a viscosity of 3260 mPas at 23° C. is obtained. The residual HDI monomer content is 0.05%.

### Example 2

### Prepolymer Production (HDI)

1000 g (4.59 mol) of polypropylene glycol with a hydroxyl value of 515 mg KOH/g and 3850 g (22.94 mol) of hexamethylene diisocyanate (HDI) are reacted at approx. 80 to 90° C.

At the end of the reaction time of 9 hours the prepolymer has a constant NCO content of 13.2%. The prepolymer is then largely freed from excess HDI monomer by distillation in a short-path evaporator at 180° C. and 0.1 mm Hg.

A medium-viscosity prepolymer having an isocyanate content of 12.5% and a viscosity of 4500 mPas at 23° C. is obtained. The residual HDI monomer content is 0.35%.

### Example 3

### Prepolymer Production (Desmodur® N 3400)

1000 g (0.5 mol) of polypropylene glycol with a hydroxyl value of 56 mg KOH/g and 2815 g (7.3 mol) of Desmodur® N 3400 from Bayer MaterialScience AG (dimer of hexamethylene diisocyanate with a 21.8% NCO content and 0.5% free HDI monomer) catalysed with 20 ppm of dibutyl tin dilaurate are reacted at approx. 40° C.

At the end of the reaction time of 6 hours the prepolymer has a constant NCO content of 14.9%. The prepolymer is then stabilised with 20 ppm of dibutyl phosphate.

A low-viscosity prepolymer having an isocyanate content of 14.9% and a viscosity of 663 mPas at 23° C. is obtained. The content of free HDI monomer is 0.19%.

### Example 4

### Examination with a Drying Recorder (Test Description)

A film is applied with a knife (250 μm) to a glass plate previously cleaned with ethyl acetate and immediately placed in the drying recorder. The needle is loaded with a weight of 10 g and moves over a 35 cm section for a period of 360 minutes.

The drying recorder is located in a climate-controlled room at 23° C. and 50% relative humidity.

100 g of the prepolymer from Example 1 are mixed with various commercial catalysts such that a working time of approx. 25 to 60 minutes is achieved with the drying recorder (visible appearance of a continuous trace of the needle in the film).

The full cure time is given as the time at which the continuous trace of the needle disappears from the film.

| | Prepolymer | | | |
|---|---|---|---|---|
| Example | from | | Amount | Full cure time |
| 4 | example | Catalyst | [wt. %] | [min] |
| A | 1 | none | | >360 |
| B | 1 | DMDEE | 0.5 | >360 |
| C | 1 | DMDEE | 1.0 | >360 |
| D | 1 | DMDEE | 1.5 | >360 |
| E | 1 | Jeffcat ZF10 | 0.5 | 219 |
| F | 1 | Jeffcat ZF10 | 1.0 | 78 |
| G | 1 | Jeffcat ZF10 | 1.5 | 42 |
| H | 2 | none | | >360 |
| I | 2 | Jeffcat ZF10 | 0.5 | 97 |
| J | 2 | Jeffcat ZF10 | 1.0 | 52 |
| K | 2 | Jeffcat ZF10 | 1.5 | 48 |
| L | 3 | none | | >360 |
| M | 3 | Jeffcat ZF10 | 1.5 | 116 |

Key:
DMDEE 2,2′-Dimorpholinyl dimethyl ether
Jeffcat ® ZF 10 N,N,N′-Trimethyl-N′-hydroxyethylbis(aminoethyl) ether

As the table shows, greatly reduced full cure times are only achieved with the catalyst according to the invention N,N,N′-trimethyl-N′-hydroxyethylbis(aminoethyl) ether (Example 4E-G, 4 I-K and 4 M) used in amounts of 0.5 to 1.5 wt. %.

### Example 5

Long-term storage tests at 50° C. in aluminium flasks were performed with the catalysts from Example 4A and 4 E-M. Aliphatic prepolymers can be classed as stable in storage if their viscosity less than doubles when stored for 14 days at 50° C.

The NCO contents and viscosities at 25° C. were determined.

| | Formulation | Viscosity after | NCO content |
|---|---|---|---|
| Example | from | 0/7/14 days | after 0/7/14 days |
| 5 | Example | [mPas] | [%] |
| A | 4 A | 2440/2668/2809 | 17.15/17.14/17.07 |
| E | 4 E | 2443/2994/3423 | 17.51/16.56/16.22 |
| F | 4 F | 2112/3355/4134 | 16.69/15.88/15.45 |
| G | 4 G | 2845/3858/4280 | 16.27/15.40/15.11 |
| H | 4 H | 3077/3262/3429 | 12.72/10.82/13.32 |
| I | 4 I | 3240/3387/3509 | 12.31/11.17/13.05 |
| J | 4 J | 3472/3591/3706 | 12.04/11.78/12.71 |
| K | 4 K | 3656/3928/4030 | 11.59/11.18/10.46 |
| L | 4 L | 700/699/724 | 14.82/14.65/14.69 |
| M | 4 M | 785/842/890 | 13.59/13.35/13.37 |

A slight adverse affect on storage stability is observed with the Jeffcat® ZF 10 catalyst as compared with the uncatalysed prepolymer. From an application-related perspective, however, all prepolymers catalysed with Jeffcat® ZF 10 are sufficiently stable in storage.

1.-10. (canceled)

11. A moisture-curing isocyanate-group-containing prepolymer based on aliphatic polyisocyanates having isocyanate contents of from 2 to 20 wt. % and containing N,N,N′-trimethyl-N′-hydroxyethylbis(aminoethyl)ether as a catalyst.

12. The prepolymer according to claim 11, wherein the catalyst is used in an amount of from 0.01 to 3 wt. %, relative to the prepolymer.

13. The prepolymer according to claim 11, wherein the catalyst is used in an amount of from 0.5 to 1.5 wt. %, relative to the prepolymer.

14. The prepolymer according to claim 11, wherein the prepolymer has an isocyanate group content of from 3 to 17 wt. %.

15. The prepolymer according to claim 11, wherein the aliphatic polyisocyanates comprise hexamethylene diisocyanate and/or its derivatives as a monomeric diisocyanate.

16. The prepolymer according to claim 11, wherein the aliphatic polyisocyanates comprise isophorone diisocyanate and/or its derivatives.

17. The prepolymer according to claim 11, wherein the prepolymer has a content of monomeric diisocyanates of less than 1.0%.

18. Adhesives, coating compounds, or sealants obtained from the prepolymer according to claim 11.

19. A polyurethane hot melt system comprising the prepolymer according to claim 11.

20. The polyurethane hot melt system of claim 19, wherein the prepolymer can be applied at high temperatures, build up strength as it cools, and then reacts with moisture.
